(19) United States
(12) Patent Application Publication
(10) Pub. No.: US 2009/0228242 A1
(43) Pub. Date: Sep. 10, 2009

(54) MEASURING SUSTAINABILITY, VIABILITY, AND VALUE PROPOSITION OF A SYSTEM

(76) Inventor: Ayman E. Nassar, Clarksville, MD (US)

Correspondence Address: HOFFMAN WARNICK LLC, 75 STATE ST, 14 FL, ALBANY, NY, 12207, US

(21) Appl. No.: 12/045,413

(22) Filed: Mar. 10, 2008

(51) Int. Cl. G06F 15/00

(52) U.S. Cl. 702/186

(57) ABSTRACT

A system, method and program product for measuring sustainability of a system. A system is disclosed that includes a plurality of drivers that relate to a structure of a defined system, a weighting system for assigning a weight to each of the plurality of drivers, a system for evaluating each of the plurality of drivers for the defined system; and a system for calculating a composite sustainability metric based on an evaluation and weight of each of the plurality of drivers.

### FIELD OF THE INVENTION

This disclosure relates to generally to evaluating systems, and more particularly relates to measuring sustainability.

### BACKGROUND OF THE INVENTION

Systems, such as software systems, typically have some useful life span before they are otherwise considered obsolete. Obsolescence can be defined as the state of a system when it no longer meets the needs that it was realized to satisfy for a particular group of stakeholders. A system becomes obsolete when it can no longer provide the value to a group of users it was developed for. This means that a system could become obsolete from the perspective of one user group but still viable from the perspective of another user group.

On the contrary, sustainment or sustainability of a system is defined as the system's continuation of operations and mission fulfillment without degradation or giving way, confined to the scope intended at the time of development of the system. Sustainability includes all the relevant sustainability processes that are required for the system to remain functional in the present and future based on current and future stakeholder needs.

System viability is a key indicator of how much a particular system could develop and grow. This includes not only from a functional perspective, but also from an application perspective. Viability may be defined as the ability of a system to provide its mission, develop and grow to accomplish modified missions, or to satisfy a change in the scope of the original mission. The mission is defined from the perspective of a set of stakeholders. Different stakeholders might have a different mission expectation and hence their view of the level of viability might be different.

Understanding the sustainability and viability of a system, and how those impact valuation of the system, can play an important role within an organization. In the case of either an existing system or one under development, sustainability and viability can help organizations assess the worth of a system, e.g., how much longer can the system be utilized before it is obsolete, how closely can it fulfill the needs of the organization or target market, etc.

Unfortunately, the current art provides few solutions for measuring sustainability and viability of a system. Accordingly, a need exists for a process that can objectively measure such concepts.

### SUMMARY OF THE INVENTION

The present invention relates to a system, method and program product for evaluating sustainability of a software system. In one embodiment, there is a system for measuring sustainability of a defined system, comprising: a plurality of drivers that relate to a structure of a software system; a weighting system for assigning a weight to each of the plurality of drivers; a system for evaluating each of the plurality of drivers for the defined system; and a system for calculating a composite sustainability metric based on an evaluation and weight of each of the plurality of drivers.

In a second embodiment, there is a method for measuring the sustainability of a system, comprising: providing a plurality of drivers that relate to a structure of the system; assigning a weight to each of the plurality of drivers; evaluating each of the plurality of drivers for the system; and calculating a composite sustainability metric based on an evaluation and weight of each of the plurality of drivers.

In a third embodiment, there is a computer readable medium having a computer program product stored thereon for measuring the sustainability of a software system, comprising: program code for providing a plurality of drivers that relate to a structure of a software system; program code for assigning a weight to each of the plurality of drivers; program code for evaluating each of the plurality of drivers for the software system; and program code for calculating a composite sustainability metric based on an evaluation and weight of each of the plurality of drivers.

In a fourth embodiment, there is a method for deploying a system for measuring sustainability of a software system, comprising: providing a computer infrastructure being operable to: provide a plurality of drivers that relate to a structure of a software system; assign a weight to each of the plurality of drivers; evaluate each of the plurality of drivers for the software system; and calculate a composite sustainability metric based on an evaluation and weight of each of the plurality of drivers.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a computer system having a sustainability measurement system in accordance with an embodiment of the present invention.

FIG. 2 depicts a table showing weights assigned to different drivers in accordance with an embodiment of the present invention.

FIG. 3 depicts a valuemeter for assessing obsolescence, sustainability and viability in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

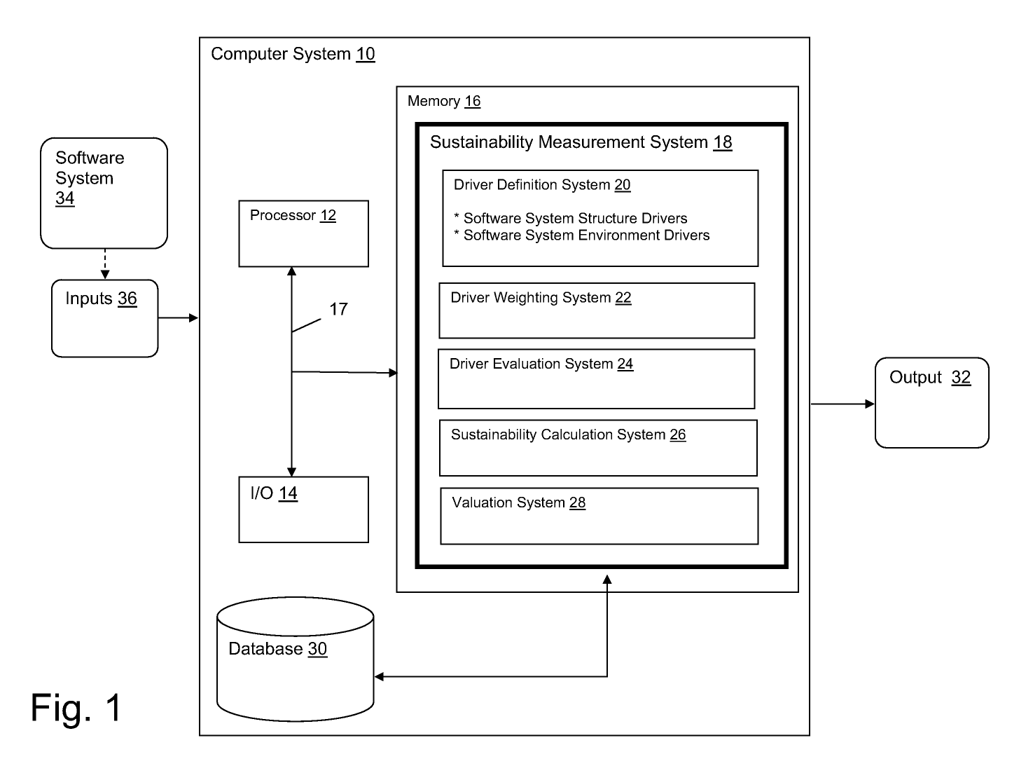

Referring to the drawings, FIG. 1 depicts a computer system 10 having a sustainability measurement system 18 for evaluating the sustainability of a defined system and providing some measurement output 32. In this illustrative embodiment, the defined system comprises a software system 34. However, it is understood that the processes and systems described herein could be used to evaluate the sustainability of any type of system (e.g., hardware, firmware, middleware, a control system, a communication system, a mechanical system, a fabrication process, etc.). Sustainability measurement system 18 generally includes: a driver definition system 20 for defining a set of drivers that impact sustainability; a driver weighting system 22 for assigning a weight to each driver; a driver evaluation system 24 for determining values for each driver, e.g., based on inputs 36, ascertained from an analysis of the software system 34; a sustainability calculation system 26 for calculating a sustainability metric for the software system 34, and a valuation system 28 for indicating a relationship between an obsolete, sustainable, and viable system. In one illustrative embodiment, output 32 may comprise a composite sustainability index combined with a relative system valuation.

In one illustrative embodiment, driver definition system 20 defines two types of drivers, structure drivers and environment drivers. Structure drivers relate to the actual structure of the software system 34 which are controllable by the system designer. Environment drivers relate to external factors that can be beyond the control of the software designer but impact the sustainability of the system. Structure drivers generally include: functionality, maintainability, security, scalability, supportability, configuration management, interoperability, viability, reliability, availability, testability, modularity, upgradeability, adaptability, portability, compatibility, and performance. Environment drivers include: forecasting, innovation, planning, rehosting and policies. Below is an overview of these drivers.

Maintainability is a key driver in extending the life of software system 34. One key aspect of ensuring software system maintainability is to embed maintainability early during the acquisition process as part of the architecture and design phases of the software system 34. The core to achieving and improving maintainability is to identify and understand what makes the maintenance of a software system 34 difficult.

Technical teams have more flexibility maintaining custom-built systems than a COTS (commercial off the shelf) product, as access to the source code and internal design decisions is possible. Approaches have been defined to maintain COTS systems during the design phase. These approaches include replacing the system with an upgraded release, developing a wrapper around the faulty software system, system reconfiguration, debugging the COTS using user interfaces and communicating results with the COTS developer, system monitoring with configuration capabilities for system tuning, encapsulated product collaborations, controlled interfaces, controlled dependencies, minimal system coupling, consistent failure handling, high level of user visibility, and minimal build and deployment effort. These approaches are also applicable to custom developed software.

Studies have found that maintainability is one of the longest and most expensive phases of a software system 34 throughout its life-cycle. The problem is even further visible in COTS software systems which are usually more expensive and difficult to maintain than custom built software systems.

Software systems must be secure to remain sustainable and be able to continue to be allowed to be deployed. Enterprise policies govern the deployment of software systems across organizations. Operating systems, servers, and databases are usually the software systems under high scrutiny to ensure data integrity, privacy and authenticity; in addition to authorized access and control. Security is a key factor in the sustainability of a software system 34, as sacrificing security could render the system inoperable or even harmful. Examples include air traffic controller systems, power plants, defense systems and many others.

Scalability is another area which could affect the useful lifetime of a software system 34. Scalability however is not as complicated and expensive as maintenance and security. Unlike security, scalability workarounds exist that can extend the sustainment of a software system 34. For example, a software system 34 that reaches the upper limit of scalable operations could be sustained through adding additional software systems on separate hardware platforms.

The ability to support a software system 34 is another factor for improving sustainment. Supportability involves the availability of human expertise and knowledge, as well as technology, tools and processes that could provide operational, functional, system and technical support. In some cases, providing supportability could be as costly and complex as providing security capabilities; in other cases it could be trivial.

The ability to manage and control configuration changes is also a factor improving the sustainment of the software system.

As software systems interact with other external systems the value of the software system improves the more the software system 34 is able to interface, receive and transmit information to a larger set of systems. A software system 34 that is able to be a part of a larger value chain would improve its sustainment, unlike a system that interoperates with a smaller set of systems. Interoperability is the software system's ability to operate with another software system of similar mission but different developer.

Reliability is related to sustainability from the perspective that a less reliable software system will be less appealing to its users, simply due to the fact that it is not as dependable as other available software systems. This drop in interest will result in a natural death of the software system when users migrate over to more reliable systems. It is worth noting however that a software system which has no competing systems but has low reliability characteristics could very well remain sustainable and of utility value as it is the only choice available. It is important to note that from an end-user's perspective, an unreliable hardware system which hosts the software system will reflect on the perceived reliability of the software system.

Similar to reliability, the higher the availability of a software system 34, the more sustainable it becomes. Availability is defined as the measure of probability that the software system will be operational and capable of producing expected function and utility. If a software system 34 is installed and configured and a hardware subsystem which the software requires to operate is no longer available, the software will automatically become unavailable. As such one can expect software system availability to be less than that of other systems they are dependent on.

Software systems require testing throughout the life-cycle. This is a key characteristic of software systems even if no new development is occurring. The fact that during software implementation, design teams and test teams cannot possibly test or even analyze and predict every possible state and mode of a complex software system leads to the need to perform in-field testing to verify that configuration changes and parameter tuning does not alter the behavior of the system. The inability to test a software system 34 could shorten its utility life-time as it could become more costly to operate.

Adherence to standards has had large success in the hardware system domain. Key areas of standardization for software are interfaces, data and message formats.

As a software system 34 becomes more modular, it becomes easier to maintain, test, configure, update and secure. As a result, modular systems will tend to be more sustainable than monolithic systems.

Software upgrades are a reality; systems need to be upgraded to extend their lifetime and sustainability. There are countless examples of software systems being upgraded on almost a daily basis.

Adaptability in software systems relates to the software's ability to use information about changes to its environment to maintain its characteristics and behavior. This could result in an improvement in behavior compared to a non-adaptive system which is exposed to the same environmental impact. Adaptive computing is becoming increasingly important in complex software systems, autonomic computing and web services. It can be assumed that the more adaptive the software system is, the longer it could satisfy the needs of the users. However it has to be noted that a key component of adaptive software systems is feedback handling mechanisms and approaches. Common approaches are dynamic programming languages, agent technology, decision theory, reinforcement theory and probabilistic networks. Software rejuvenation is an approach whose goal is to make software more fault tolerant to decay due to defect and bug build-up putting the software system into a state of instability. It is important to note that software decay is different from software obsolescence. Obsolescence in concerned with the inability to meet the stakeholders' mission, while decay is the inability to run in a fault-free state. Some of these approaches might require additional resources and complexity to operate efficiently which could result in an early obsolescence of the system.

Portability in software systems is the ability to operate across various operating environments. The more a software system is portable, the higher the chance it will survive and retain its utility should an operating system or hardware infrastructure become obsolete or no longer available. Approaches and technologies to improve software portability have been available for quite some time. Examples are middleware such as Portable Object Adapter (POA) developed to allow portable CORBA server applications. Standards such as POSIX, DCE, X-Windows, ANSI C, ODBC, SQL, Win32 APIs, RPC and NFS are all developed to improve software system integration and portability. Portability has a direct impact on software system integration and is of great significance in “systems of systems” and large cross-enterprise systems. The value of portability is expected to increase as services become more Internet-based and custom oriented requiring various components from a multitude of software systems to operate together to provide a customized service to an end-user. In a survey conducted to identify important challenges for software development, portability was ranked high on the list, and is increasingly identified as a desirable attribute of a software system for purposes of reuse. Portability also finds heavy application in the area of protocol development; an example is the case of Internet protocol stacks which are mostly dependent on the original BSD implementation.

Software system compatibility refers to the ability of a software system to operate and interface with other hardware and network systems. Software compatibility is often defined as the ability of a software system to run on specific computer hardware. This definition includes in it portability, for if a software system could operate on multiple types of computing environments, it is compatible with these computing environments and portable. Portability and compatibility may be combined into a single factor.

Viability a key indicator of how much a software system 34 could develop and grow. This includes not only from a functional perspective, but also from an application perspective. Consider the case of a simple operating system such as MS-DOS. Although the software operating system became commoditized in the mid 1990s, it still has useful applications for example in home appliances. Assuming that with no further improvement in a 1996 release of MS DOS 6.x it can still be deployed in a toaster, this would mean that it is still viable and is still sustainable. The growth and development here is not in features and capabilities, but rather in application. In the toaster example above, the operating system mission changed from operating applications on a computer to operating utilities on a toaster, the operating system in this case is still viable.

Viability is defined as the capability of living and the ability to grow and develop. System viability has also been defined as a combined technical and economic value measure of the producibility, supportability and evolvability of a system. Viability may thus be defined as the ability of a system to provide its mission, develop and grow to accomplish modified missions, or to satisfy a change in the scope of the original mission. The mission is defined from the perspective of a set of stakeholders. Different stakeholders might have a different mission expectation and hence their view of the level of viability might be different.

The difference between sustainability and viability is subtle; however it is of great impact. A sustainable system might not be viable. An example is a legacy software system that is still in operation that can still process data and perform the functions it was developed for. However, the system might not allow for new developments or growth to accomplish additional capabilities.

Software system sustainability could be extended by simple improvements such as faulty part replacements, debugging, testing, minor changes, upgrades, portability to another platform and so on. On the other hand, viability requires a major change in the software system which can be accomplished through major developments and possibly architectural and design changes.

It is worth mentioning that system viability considers not only an expanded mission of a software system, but also a descope of the mission where is becomes more specialized. A software system whose mission scope is narrowed is also considered viable. This is due to the fact that the software system still allows modification of its architecture and design to make use of it in a modified mission.

Performance is both an attribute of a system and a behavior. It is an attribute during the design and development phases. Once the software system is deployed in production, performance becomes a behavior. Since we are interested in factors impacting the structure of the software system, then the factors are applicable mostly during design and development. Hence performance is an attribute that could affect the system's structure.

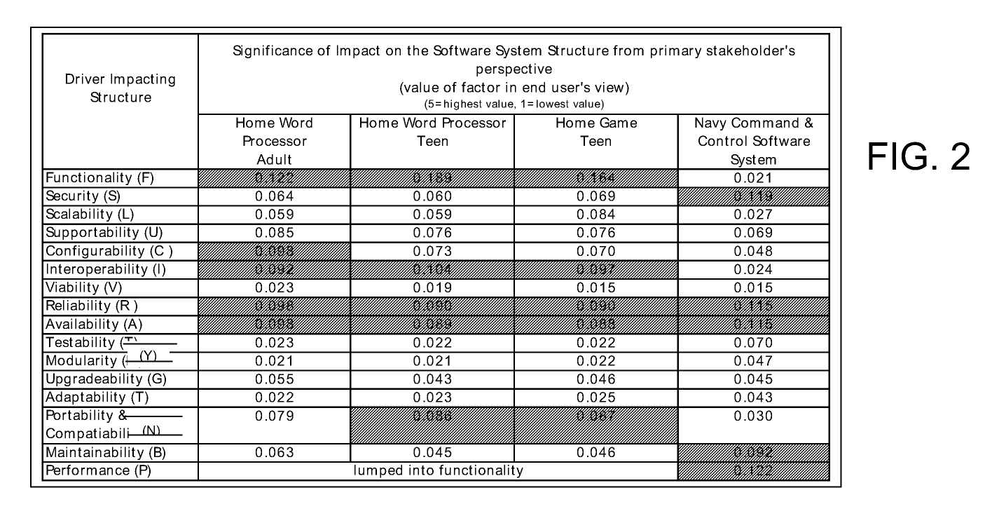

FIG. 2 depicts a table of four different illustrative software systems and weighting schemes that are applied to the software systems, which would typically be provided by stakeholders. Analytical Hierarchy Process (AHP) may be utilized to perform pair-wise comparisons of each driver's relevance and impact to the software system structure from the stakeholder's perspective. The examples include a home word processor for use by an adult, a home word processor for use by a teen, a home game for use by a teen, and a navy command and control software system.

First, a composite sustainability metric S is defined as follows:

S=(a*F)+(b*S)+(c*L)+(d*U)+(e*C)+(f*I)+(g*V)+(h*R)+(i*A)+(j*T)+(k*M)+(l*G)+(m*Y)+(n*P)+(o*B)+(p*N).

Where the variables (F, S, L, U, C, I, V, R, A, T, M, G, Y, P, B, N) are the percentile rates of each of the respective drivers listed in the table of FIG. 2, and are measured using, e.g., industry standard methods in the domain. Worth mentioning is that this composite measure is valid for values of F, S, L, U, C, I, V, R, A, T, M, G, Y, P, B, N that are greater than 0. For availability (A), common logic can support the earlier claim that absence of availability, i.e., A=0%, renders the system obsolete.

Each driver is weighted using its relative significance of impact on the software system, i.e., a, b, c, d, e, f, g, h, I, j, k, l, m, n, o, p. Note that in a development or valuation process, a system engineer may decide to choose the top X drivers where X could be an arbitrary number based on the level of accuracy desired and available data. Thus, it is not necessary to utilize all the drivers to evaluate a given software system.

In the first scenario, a word processor used by a professional adult, the goal might be to provide a highly functional word processor for use in home projects, volunteer work in community, etc. Word processors are common applications. The application is simple and readily available, research subjects for a survey could be commonly found and a survey could be conducted to verify our assumptions. It is also a good example of a non-mission critical software application which is still used by professionals and considered to be of some moderate significance in their daily lives.

Functionality is most important point of interest. Adults in their 30s or 40s who use a word processor at home use it mostly for home projects, to write letters to a service provider, the children's teacher, or volunteer work they might be involved in their local communities. Technical support and the ability to support the word processor is assumed to be important to a home user who might be of average technical level and unable to solve technical problems with external support

The home user expects the word processor to be interoperable with other word processors on different computers and platforms. For instance, it is important for a MS-Word home user to be able to exchange files with a MAC home user. Similarly, compatibility of MS-Word for example with different hardware platforms is as important as interoperability and functionality. These are important as the home user is a single administrative entity and will most likely be interacting with other external entities than internally within the family.

Reliability and availability would also be factors of interest to the home user and probably more important that security, but less than functionality, technical support, interoperability and compatibility.

Security is a concern to home users, but since the software system is used mostly at home for non-work related deliverables, security is not critical. Examples clarifying the drivers include:
Functionality: The quantity of features and capabilities the word processor has.
Security: Security capabilities the word processor, such as password protection and the level of protection it has against security threats.
Scalability: How many users can use the word processor at the same time, the number of open files, the total number of files that can be processed, the maximum number of pages in a file.
Supportability: The level of technical support available to the end user via the vendor or third party
Configurability: The ability to configure the word processor to provide flexible and custom capabilities, for example ability to configure page sizes, printer types, printout color options and other similar features
Interoperability: Ability of exchanging files with other people using word processors from other vendors, for example MAC, PC's or others and the ability to open files created using older versions of the same software
Viability: The ability to modify the word processor to provide a different set of features such as web and desktop publishing
Reliability: The word processor operating as expected with the type of files the user commonly uses such as pictures, graphics, text and spreadsheets without crashing or operating in an unpredictable manner
Availability: The operational availability of the word processor when needed
Testability: The ability to test the word processor for fixing problems and issues
Modularity: The ability to uninstall and re-install particular components of the word processor, while keeping the remaining functions and capabilities of the word processor intact and operational
Upgradeable: Ability to upgrade the word processor to future versions.
Adaptability: Ability of the word processor to be used to edit new types of files such as html pages, or XML documents automatically by switching to html or xml mode, also the ability of the word processor to run in a basic mode to reduce processing load on the hardware while other applications, or processes are active.
Portability and compatibility: Ability of word processor to operate on other operating systems and on different hardware computers, for example Dell, IBM, HP
Maintainability: Ability of the home user to maintain the word processor by deleting temporary files, resetting word processor settings to default values, installing patches for performance improvement

Using the sustainability equation above for the case of a professional adult using a home word processor, the top five significant drivers may be chosen.

S_{p-wp}=(0.122*F)+(0.098*C)+(0.092*I)+(0.098*R)+(0.098*A)

Where S_{p-wp} is the sustainability of a word processor WP used by a professional adult.

The values of F, C, I, R and A are calculated using approaches and methods known in each of the domains. Measuring some drivers such as reliability and availability has been covering extensively in research and industrial domains. Other drivers such as the level of functionality can be measured by using Quality Function Deployment (QFD), or any custom functionality specification measurement process. Configurability could be measured by the number of features that can be changed, change control abilities and other metrics. Measuring other areas might be less wide-spread, and could require research to identify approaches suitable for measuring.

In the case of the word processor for a teen, the software system should provide a highly functional word processor for use in home projects and school homework. The application is simple and readily available, research subjects for a survey could be commonly found and a survey could be conducted to verify assumptions. It is also a good example of a non-mission critical software application which is still used by teens and can be compared to the case of usage by an adult.

Assumptions include:
Functionality is most important point of interest. Teens use a word processor at home mostly for home projects and school homework. Performance and functionality can thus be grouped into one factor.
Teens will expect the word processor to be interoperable with other word processors on different computers and platforms. This is especially important to a teenager who shares files with teachers and peers. Similarly, compatibility with different hardware platforms is as important as interoperability and functionality.
Technical support and the ability to support the word processor is assumed to be important to a teen who might be of average technical level and unable to solve technical problems without external support.
Reliability and availability would also be factors of interest to the home user and probably more important that security, but less than functionality, technical support, interoperability and compatibility.
Security is usually not a concern to teens.
   Examples clarifying the factors:
Functionality: The quantity of features and capabilities the word processor possesses.
Security: Security capabilities the word processor, such as password protection and the level of protection it has against security threats.
Scalability: How many users can use the word processor at the same time, the number of open files, the total number of files that can be processed, the maximum number of pages in a file.
Supportability: The level of technical support available to the end user via the vendor or third party.
Configurability: The ability to configure the word processor to provide flexible and custom capabilities, for example ability to configure page sizes, printer types, printout color options and other similar features.
Interoperability: Ability of exchanging files with other people using word processors from other vendors.
Viability: The ability to modify the word processor to provide a different set of features such as web and desktop publishing
Reliability: The word processor operating as expected with the type of files the user commonly uses such as pictures, graphics, text and spreadsheets without crashing or operating in an unpredictable manner.
Availability: The operational availability of the word processor when needed.
Testability: The ability to test the word processor for fixing problems and issues.
Modularity: The ability to uninstall and re-install particular components of the word processor, while keeping the remaining functions and capabilities of the word processor intact and operational
Upgradeable: Ability to upgrade the word processor to future versions.
Adaptability: Ability of the word processor to be used to edit new types of files such as HTML pages, or XML documents automatically by switching to html or xml mode, also the ability of the word processor to run in a basic mode to reduce processing load on the hardware while other applications, or processes are active.
Portability and compatibility: Ability of word processor to operate on other operating systems and on different hardware computers.
Maintainability: Ability of the home user to maintain the word processor by deleting temporary files, resetting word processor settings to default values, installing patches for performance improvement.

Referring to sustainability equation for the case of a teen using a home word processor, the top five significant drivers can again be chosen. The then becomes,

S_{t-wp}=(0.189*F)+(0.104*I)+(0.090*R)+(0.089*A)+(0.086*P),

where S_{t-wp} is the sustainability of a word processor WP used by a teen.

In the case of a computer video game for a teen, it may be the goal to provide a high animation multi-user video game. Conducting a survey to verify assumptions could be conducted easily and at a low cost by soliciting feedback from local community centers and schools.

In this case, using the top five drivers results in a sustainability equation as follows:

Sₜ₋ᵥ=(0.164*F)+(0.097*I)+(0.090*R)+(0.088*A)+(0.087*P)

where Sₜ₋ᵥ is the sustainability of a video game V used by a teen.

In the case of a naval command and control center, the goal may be to provide a reliable, secure, available, real-time system. Security, reliability and availability would thus be very important factors of interest to the users and operators. Real-time performance would also be an important attribute as well as technical support, and maintenance. Functionality may not be as critical.

In this case, using the top five drivers results in a sustainability equation as follows:

S_{n-c}=(0.119*S)+(0.115*R)+(0.115*A)+(0.092*B)+(0.122*N)

Where S_{n-c} is the sustainability of a naval command center operated by a group of commanders.

Once the sustainability equation is determined, an evaluator can measure individual driver values using known or developed processes. A final value S can thus be generated. This process can also be used to allow developers to weight the most important drivers ahead of time, and thus focus development efforts in those areas.

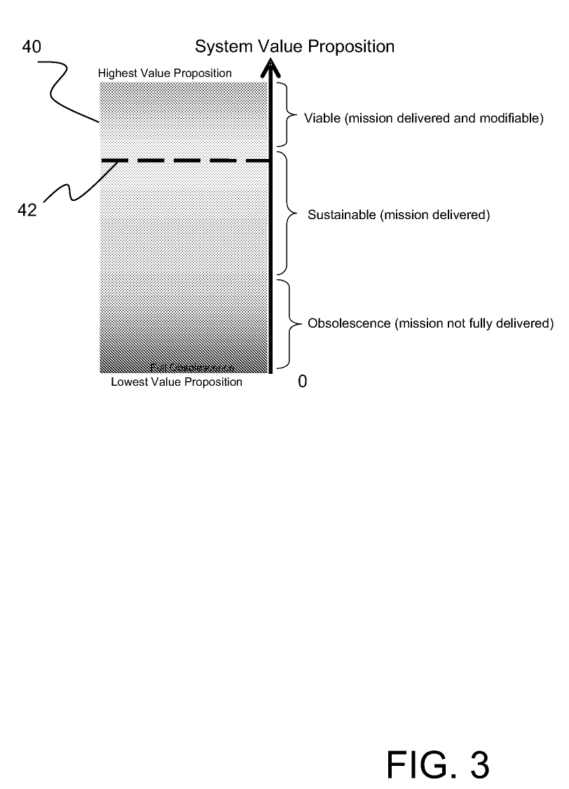

As noted above in FIG. 1, sustainability measurement system 18 provides a valuation system 28 that can be used as an indicator illustrating the relationship between an obsolete, sustainable and viable software system. Valuation system 28 determines the state of a software system and where it falls in a life phase valuemeter 40, such as that shown in FIG. 3. The valuemeter 40 presents a relative position 42 or index of a system at a particular point in time. The more the index is towards the top zone, the higher the viability of the system and its value proposition, the more the index approaches the bottom zone, the more obsolete it becomes. A sustainable system would have an index in the middle zone.

The described approach to assess software system sustainability is of great use in developing products with extensible useful life-times. The approach also identifies key factors that a software architect or a systems engineer needs to analyze to improve the sustainability. These drivers and their relative importance may differ from one software system to another and from one stakeholder to another.

This approach in measuring the sustainability of a system can be used by system developers and applied to different groups of stake-holders to identify “sweet spots” in the system's capabilities, and to optimize the system's sustainability across multiple stakeholders. For example in the case of the word processor (WP) described above, it can be assumed that adult and teen are using the same word processor WP, and hence the reliability and availability will be the same in the case of a adult and a teen using it.

As noted above:

S_{p-wp}=(0.122*F)+(0.098*C)+(0.092*I)+(0.098*R)+(0.098*A)

And

S_{t-wp}=(0.189*F)+(0.104*I)+(0.090*R)+(0.089*A)+(0.086*P)

Ignoring the small differences in weights of I, R and A between the two equations (2) and (3), one could assume:

S_{p-wp}−S_{t-wp}≈(0.098*C)−(0.086*P)−(0.067*F)

From this once could deduce that to narrow the sustainability gap between these two stakeholder groups there is a need to balance between the configurability and the portability features. In other words, by focusing heavily only on configurability features of interest to an adult, and portability features of interest to a teen, the system designer might be able to achieve a highly sustainable system in the perspective of both stakeholders—without investing too much in configurability options a teenager might be interested in, or portability features that an adult might be interested. Obviously, this generalization could dilute the value proposition for a particular group but could enhance the overall value proposition to all stakeholders. Another approach the system designer can follow is to develop two variations of the WP system—one for the adult, and one for the teen—focusing on the unique drivers for each variation.

As noted above, sustainability measurement system 18 may also consider environmental drivers, as well as the structural drivers discussed above. These drivers may include forecasting, which involves predicting future technology, business, market, economic and regulation demands and changes. Forecasting may also include technology insertion and risk management. A second driver is innovation, which in software acquisition processes, technical management and business models could provide techniques and approaches for increasing the longevity of a software system. A third driver, planning, identifies direct or indirect areas of improvement in a software system or other supporting processes to improve sustainability and includes forecasts, analysis, decision-making, vision development, value definition, mission development, problem statements, assumptions, constraints, estimates, plans and representations. The fourth driver is rehosting as a means to modify existing software to operate in a new development environment. A fifth driver is policies and regulations that might impact how a product can be deployed.

Referring again to FIG. 1, it is understood that computer system 10 may be implemented as any type of computing infrastructure. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 10 comprising a sustainability measurement system 18 could be created, maintained and/or deployed by a service provider that offers the functions described herein for customers. That is, a service provider could offer to deploy or provide the ability to measure the sustainability of a system as described above. Furthermore, some or all of the steps, processes, or systems described herein could be performed manually.

It is understood that in addition to being implemented as a system and method, the features may be provided as a program product stored on a computer-readable medium, which when executed, enables computer system 10 to provide a sustainability measurement system 18. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 16 and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A system for measuring sustainability of a defined system, comprising:
a plurality of drivers that relate to a structure of the defined system;
a weighting system for assigning a weight to each of the plurality of drivers;
a system for evaluating each of the plurality of drivers for the defined system; and
a system for calculating a composite sustainability metric based on an evaluation and weight of each of the plurality of drivers.

2. The system of claim 1, wherein the plurality of drivers are selected from the group consisting of: functionality, maintainability, security, scalability, supportability, configuration management, interoperability, viability, reliability, availability, testability, modularity, upgradeability, adaptability, portability, compatibility, and performance.

3. The system of claim 1, wherein the composite sustainability metric is based on a subset of the plurality of drivers having the n highest weights.

4. The system of claim 1, further comprising a valuation system for indicating whether a state of the defined system is an obsolete, sustainable or viable system.

5. The system of claim 1, wherein the evaluation of each driver is based on industry standard techniques.

6. The system of claim 1, wherein the plurality of drivers includes environmental drivers selected from the group consisting of: forecasting, innovation, planning, rehosting, and policies.

7. A method for measuring the sustainability of a system, comprising:
providing a plurality of drivers that relate to a structure of a system;
assigning a weight to each of the plurality of drivers;
evaluating each of the plurality of drivers for the system; and
calculating a composite sustainability metric based on an evaluation and weight of each of the plurality of drivers.

8. The method of claim 7, wherein the plurality of drivers are selected from the group consisting of: functionality, maintainability, security, scalability, supportability, configuration management, interoperability, viability, reliability, availability, testability, modularity, upgradeability, adaptability, portability, compatibility, and performance.

9. The method of claim 7, wherein the composite sustainability metric is based on a subset of the plurality of drivers having the n highest weights.

10. The method of claim 7, further comprising indicating whether a state of the system is an obsolete, sustainable or viable system.

11. The method of claim 7, wherein the evaluation of each driver is based on industry standard techniques.

12. The method of claim 7, wherein the plurality of drivers includes environmental drivers that relate to the impact of an environment in which the system exists on the structure of the system, wherein the environmental drivers are selected from the group consisting of: forecasting, innovation, planning, rehosting, and policies.

13. A computer readable medium having a computer program product stored thereon for measuring the sustainability of a system, comprising:
program code for providing a plurality of drivers that relate to a structure of the system;
program code for assigning a weight to each of the plurality of drivers;
program code for evaluating each of the plurality of drivers for the system; and
program code for calculating a composite sustainability metric based on an evaluation and weight of each of the plurality of drivers.

14. The computer readable medium of claim 13, wherein the plurality of drivers are selected from the group consisting of: functionality, maintainability, security, scalability, supportability, configuration management, interoperability, viability, reliability, availability, testability, modularity, upgradeability, adaptability, portability, compatibility, and performance.

15. The computer readable medium of claim 13, wherein the composite sustainability metric is based on a subset of the plurality of drivers having the n highest weights.

16. The computer readable medium of claim 13, further comprising program code for indicating whether a state of the system is an obsolete, sustainable or viable system.

17. The computer readable medium of claim 13, wherein the evaluation of each driver is based on industry standard techniques.

18. The computer readable medium of claim 13, wherein the plurality of drivers includes environmental drivers selected from the group consisting of: forecasting, innovation, planning, rehosting, and policies.

19. The computer readable medium of claim 13, wherein the system comprises a software system.

20. A method for deploying a system for measuring sustainability of a system, comprising:
providing a computer infrastructure being operable to:
provide a plurality of drivers that relate to a structure of a system;
assign a weight to each of the plurality of drivers;
evaluate each of the plurality of drivers for the system; and
calculate a composite sustainability metric based on an evaluation and weight of each of the plurality of drivers.
